(19) United States
(12) Patent Application Publication
(10) Pub. No.: US 2020/0113139 A1
(43) Pub. Date: Apr. 16, 2020

(54) SYSTEM AND DEVICE FOR PROTECTING FRUIT CLUSTERS FROM BIRDS, SQUIRRELS, DEER AND OTHER CREATURES WHILE GROWING ALONG THE BRANCHES OF FRUIT TREES

(71) Applicant: Jores Carabelaian, Darien, CT (US)

(72) Inventor: Jores Carabelaian, Darien, CT (US)

(21) Appl. No.: 16/161,176

(22) Filed: Oct. 16, 2018

(51) Int. Cl. A01G 13/10; A01G 13/02; A01G 17/00; B65D 85/52; B65D 43/16

(52) U.S. Cl. CPC A01G 13/105; A01G 13/0237; A01G 2013/006; B65D 85/52; B65D 43/162; A01G 17/00

(57) ABSTRACT

A light-transmissive fruit protection case for installation about a cluster of fruit pieces hanging from stems along or at an end portion of a tree branch. The light-transmissive fruit protection case comprises first and second case housing portions connected about a common flexible hinge structure. The first and second case housing portions each have side, top and bottom surfaces. A plurality of air and water openings formed about the side, top and bottom surfaces of the first and second case housing portions. First and second branch access ports are formed on opposing ends of the first and second case housing portions, along its longitudinal axis, so as to allow the entry and passage of a fruit tree branch. A set of reclosable fasteners are formed on the side end portions of the first and second case housing portions to releasably lock the case in its closed configuration once arranged about a cluster of fruit hanging from the tree branch.

### BACKGROUND OF INVENTION

### Field of Invention

The present invention relates to improvements in apparatus adapted for use in protecting fruit growing on tree branches, from creatures such birds, squirrels, deer and other small animals.

### Brief Description of the State of the Knowledge in the Art

Almost everyone enjoys fresh fruit, such as apples, peaches, pears and oranges, picked fresh while growing on fruit trees. Also, almost everyone understands the challenge of protecting such fruit from hungry birds, squirrels, deer and other small creatures as pieces of fruit are growing, maturing and ripening on tree branches before harvest time.

Over the years, different types of apparatus have been developed to help prevent birds, squirrels, deer, and other creatures from eating fruit growing on the branches of fruit trees.

One method involves putting the enclosing the entire fruit tree in a mesh screening, or building, that allows light and water and gases to pass through the screening, while keeping birds and squirrels out, to protect growing fruit on the branches. Various examples of prior art fruit screens are disclosed in the following Patent Application Publications: CN207383091U; KR200217212Y1; KR200245669Y1; KR200272954Y1; KR1020000058399A; KR1020090006366A; and KR1020120119928A.

Another method involves surrounding each piece of growing fruit in a plastic or metal cage designed to prevent birds from pecking through and eating the fruit while it is growing on the fruit tree branch. Various examples of prior art fruit cages are disclosed in the following Patent Application Publications: KR1020040072192A; and U.S. Pat. No. 5,233,788A.

While these conventional devices have help to hinder birds, squirrels, deer and other small animals from eating fruit growing on the branches of fruit trees, there is a great need for improved systems and devices that provide such protection but with significantly greater flexibility and usability on small fruit trees growing in millions of backyards around the world.

Clearly, there is a great need for new and improved systems and devices for protecting clusters of fruit growing along the branches of fruit trees, from birds, squirrels, deer and other small animals, while overcoming the shortcomings and drawbacks of prior art methods and apparatus.

### OBJECTS AND SUMMARY OF SUMMARY OF INVENTION

Accordingly, a primary object of the present is to provide new and improved method of and apparatus for preventing birds, squirrels, deer and other animals from eating fruit growing on fruit trees, while overcoming the shortcomings and drawbacks of prior art methods and apparatus.

Another object of the present is to provide such apparatus in the form of a new and improved light-transmissive fruit protection case for installation about a cluster of fruit pieces hanging from stems along or at an end portion of a tree branch.

Another object of the present is to provide such a new and improved light-transmissive fruit protection case comprising: first and second case housing portions connected about a common flexible hinge structure, wherein the first and second case housing portions each have side, top and bottom surfaces; a plurality of air and water openings formed about said side, top and bottom surfaces of said first and second case housing portions; first and second branch access ports formed on opposing ends of the first and second case housing portions to allow the entry and passage of a fruit tree branch; and a set of reclosable fasteners formed on the side end portions of the first and second case housing portions.

Another object of the present is to provide such a new and improved light-transmissive fruit protection case, which can be stacked in large numbers, packaged and shipped to the final destination of use.

Another object of the present is to provide a new and improved light-transmissive fruit protection case which can be arranged around different clusters of fruit growing at the end of branches on a fruit tree, as well as along the branches of the fruit tree, so as to provide a large field of protection over growing fruit against birds, squirrels, deer and other animals without using conventional tree nets, or countless numbers of single-fruit cages designed to protect single pieces of growing fruit on trees.

Another object of the present invention is to provide such a new and improved device for protecting clusters of fruit growing along or at the end of fruit tree branch, at any stage of biological development, starting from clusters of pollinated fruit blossoms on tree branches.

These and other benefits and advantages to be gained using the features of the present invention will become more apparent hereinafter and in the appended Claims to Invention.

### BRIEF DESCRIPTION OF THE DRAWINGS

The following Objects of the Present Invention will become more fully understood when read in conjunction of the Detailed Description of the Illustrative Embodiments, and the appended Drawings, wherein:

FIG. 1 is a perspective view of a fruit tree with branches bearing many clusters of fruit located along and at the end of each fruit tree branch, with many light-transmissive fruit protection cases, each arranged in its closed configuration surrounding and protecting one or more fruit clusters stemming from a branch, in accordance with the principles of the present invention;

FIG. 2 is a perspective view of a light-transmissive fruit protection case arranged in its closed configuration about a cluster of fruit pieces hanging from their stems at the end or terminal portion of a tree branch on a fruit tree, providing protection to the cluster of fruit in accordance with the principles of the present invention;

FIG. 3 is a perspective view of a light-transmissive fruit protection cases arranged in its closed configuration about a cluster of fruit pieces hanging from their stems along a portion of a tree branch on a fruit tree, providing protection to the cluster of fruit in accordance with the principles of the present invention;

FIG. 4 is a perspective view of the light-transmissive fruit protection case of the illustrative embodiment of the present invention, arranged in its closed configuration while not installed about a cluster of fruit pieces hanging from their stems along or at the end portion of a tree branch;

FIG. 4A is a first elevated end view of the light-transmissive fruit protection case of the illustrative embodiment of the present invention, arranged in its closed configuration and not installed about a cluster of fruit pieces hanging from their stems at the end or terminal portion of a tree branch;

FIG. 4B is a second elevated end view of the light-transmissive fruit protection case of the illustrative embodiment of the present invention, arranged in its closed configuration while not installed about a cluster of fruit pieces hanging from their stems along or at the end portion of a tree branch;

FIG. 4C is a first elevated side view of the light-transmissive fruit protection case of the illustrative embodiment of the present invention, arranged in its closed configuration while not installed about a cluster of fruit pieces hanging from their stems along or at the end portion of a tree branch;

FIG. 4D is a top plan view of the light-transmissive fruit protection case of the illustrative embodiment of the present invention, arranged in its closed configuration while not installed about a cluster of fruit pieces hanging from their stems along or at the end portion of a tree branch, wherein first and second branch access ports are formed on opposing ends of the first and second case housing portions to allow the entry and passage of a fruit tree branch when installed about a tree branch;

FIG. 4E is a bottom plan view of the light-transmissive fruit protection case of the illustrative embodiment of the present invention, arranged in its closed configuration while not installed about a cluster of fruit pieces hanging from their stems along or at the end portion of a tree branch;

FIG. 5A is a first perspective view of the light-transmissive fruit protection case of the illustrative embodiment of the present invention, arranged in its open configuration while not installed about a cluster of fruit pieces hanging from their stems along or at the end portion of a tree branch;

FIG. 5B is a second perspective view of the light-transmissive fruit protection case of the illustrative embodiment of the present invention, arranged in its open configuration while not installed about a cluster of fruit pieces hanging from their stems along or at the end portion of a tree branch, showing (i) the first and second case housing portions connected about a common flexible hinge structure, (ii) a plurality of air and water openings formed about the side and top and bottom surfaces of the first and second case housing portions, (iii) the first and second branch access ports formed on opposing ends of the case to allow the entry and passage of a fruit tree branch, and (iv) a set of reclosable fasteners formed on the side end portions of the first and second case housing portions;

FIG. 5C is a bottom plan perspective view of the light-transmissive fruit protection case of the illustrative embodiment of the present invention, arranged in its open configuration while not installed about a cluster of fruit pieces hanging from their stems along or at the end portion of a tree branch, showing (i) the top and bottom panels of the first and second case housing portions connected about the common flexible hinge structure, (ii) a plurality of air and water openings formed about the side and top and bottom surfaces of the first and second case housing portions, (iii) the first and second branch access ports formed on opposing ends of the case to allow the entry and passage of a fruit tree branch, and (iv) a set of reclosable fasteners formed on the side end portions of the first and second case housing portions;

FIG. 5D is an elevated end view of the light-transmissive fruit protection case of the illustrative embodiment of the present invention, arranged in its open configuration while not installed about a cluster of fruit pieces hanging from their stems along or at the end portion of a tree branch, showing (i) the first and second case housing portions connected about a common flexible hinge structure, (ii) a plurality of air and water openings formed about the side and top and bottom surfaces of the first and second case housing portions, (iii) the first and second branch access ports formed on opposing ends of the case to allow the entry and passage of a fruit tree branch, and (iv) a set of reclosable fasteners formed on the side end portions of the first and second case housing portions;

FIG. 5E is an elevated side view of the light-transmissive fruit protection case of the illustrative embodiment of the present invention, arranged in its open configuration while not installed about a cluster of fruit pieces hanging from their stems along or at the end portion of a tree branch, showing (i) the first case housing portion, (ii) a plurality of air and water openings formed about the side and top and bottom surfaces of the first case housing portion, and (iii) the first and second branch access ports formed on opposing ends of the case to allow the entry and passage of a fruit tree branch;

FIG. 5F is a top plan perspective view of the light-transmissive fruit protection case of the illustrative embodiment of the present invention, arranged in its open configuration while not installed about a cluster of fruit pieces hanging from their stems along or at the end portion of a tree branch, showing (i) the interior 3D space portions defined by the first and second case housing portions connected about the common flexible hinge structure, (ii) a plurality of air and water openings formed about the side and top and bottom surfaces of the first and second case housing portions, (iii) the first and second branch access ports formed on opposing ends of the case to allow the entry and passage of a fruit tree branch, and (iv) a set of reclosable fasteners formed on the side end portions of the first and second case housing portions;

FIG. 5G is a perspective view of a flexible strap provided with Velcro® fasteners at its end portions, for use in securing the second case housing portion to a tree branch from one end when installed using either the terminal installation method illustrated in FIG. 2, and from two ends when installed using the in-line installation method illustrated in FIG. 3;

FIG. 6 is a perspective view of a plurality of light-transmissive fruit protection cases of the illustrative embodiment of the present invention, arranged in a stacked-up open configuration for storage and shipping to destinations of use;

FIG. 7 a perspective view of a light-transmissive fruit protection cases arranged in its closed configuration about a cluster of pollinated fruit flowers, with fruit buds hanging from their stems along a portion of a tree branch on a fruit tree, providing protection to the cluster of young fruit buds in accordance with the principles of the present invention; and

FIG. 8 a perspective view of a light-transmissive fruit protection cases arranged in its closed configuration about a cluster of small immature fruit pieces hanging from their stems along a portion of a tree branch on a fruit tree, providing protection to the cluster of immature fruit pieces in accordance with the principles of the present invention.

### DETAILED DESCRIPTION OF THE ILLUSTRATIVE EMBODIMENT

Referring to the accompanying Drawings, like structures and elements shown throughout the figures thereof shall be indicated with like reference numerals, across the various illustrative embodiments of the fruit protection systems of the present invention.

To better appreciate the present invention, it will be helpful to quickly review how fruit such as apples begin to grow on trees before birds, squirrels and other creatures have a chance to eat them while hanging from a stem on a tree branch.

For an apple tree to bear fruit, each apple blossom flower that is to produce an apple must be fertilized by a process called pollination. Between April and May, apple buds blossom with pink flowers, and bees are moved into the orchard field to begin the pollination process. Often, the bees are brought at nighttime, because by that time, the bees have all returned to the hive. Apple blossoms create pollen from the stamen. Bees are attracted to the smell and the color of apple blossoms which contain the sweet nectar they require. During the day, the bees fly from flower blossom to flower blossom in search of nectar, and storing the nectar that they use to make honey when they return to the hive. While they are collecting nectar, they also collect pollen. The pollen on the flowers sticks to the bees' hair and is carried to the next flower. The pollen that is stuck to the bee from one flower blossom, travels on the bee where it is collected by the pistil of another apple blossom. Once the apple blossom is pollinated, an apple can grow. Once apple begins to grow, the apple fruit growing on the apple tree can be eaten by birds, squirrels and other small creatures. The present invention is concerned with the problem of fruit, such as apples, pears, peaches and other hanging fruit, being eaten by birds, squirrels and other small creatures, and not humans picking and eating fruit from trees in an unauthorized manner, which is another problem altogether.

### Specification of Light-Transmissive Fruit Protection Case of the Illustrative Embodiment of the Present Invention Installed About the Branches of a Fruit Tree

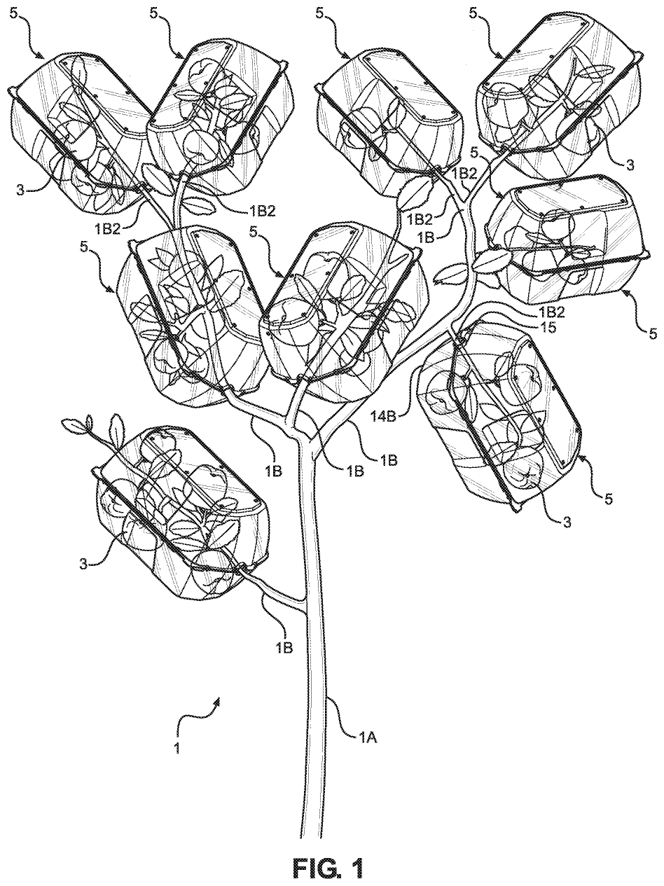

FIG. 1 shows an exemplary fruit tree 1 with a vertical trunk 1A branches 1B1 and 1B2 bearing many clusters of fruit 3 located both along a fruit tree branch 1B1 and at the end of each fruit tree branch 1B2. Each apple is connected to the branch by way of a stem portion 4. As shown, many light-transmissive fruit protection cases 5 are arranged about these clusters of fruit 3 on the tree to provide protection against birds, squirrels and other small animal creatures who desired to each the forbidden fruit on the tree 1. As shown, each fruit protection case 5 is arranged in its closed configuration surrounding and protecting one or more fruit clusters 3 stemming from a branch 1B1, 1B2 on the tree, in accordance with the principles of the present invention. In the illustrative embodiment, each fruit protection case 5 is made from a crystal-clear recyclable PET plastic material for optimal visibility and light transmission from all angles. In the illustrative embodiment, the volumetric capacity of this protection case is about 3 pints but may be more or less depending on the particular application. The protection case is slotted to allow air in and around the fruit produce growing on the stem from the branch, keeping condensation relatively low, and allowing easy transitions to different temperatures. A perimeter-locking closure ensures a secure seal around the protection case 5.

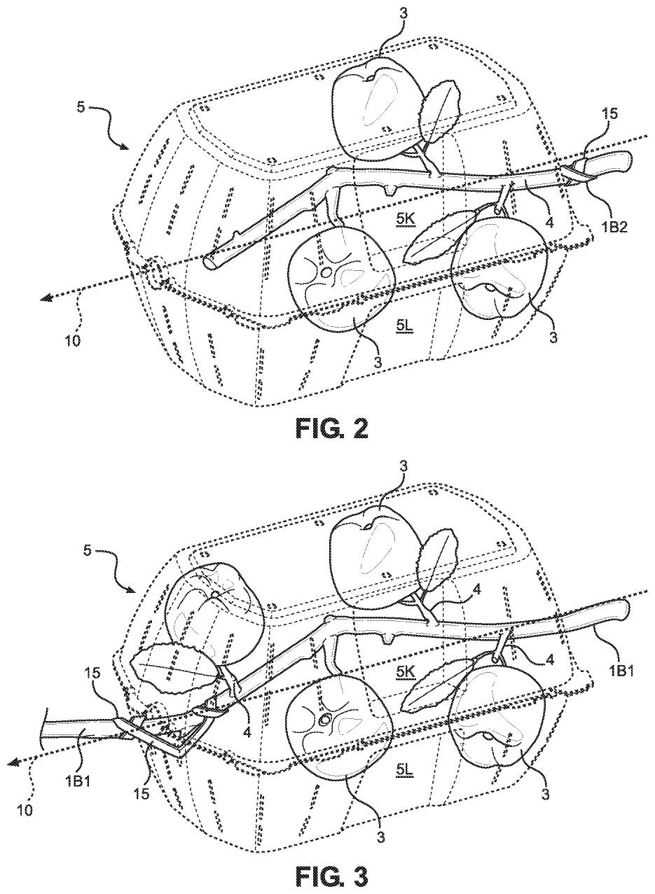

FIG. 2 shows the light-transmissive fruit protection case 5 arranged in its closed configuration about a cluster of fruit pieces 3 hanging from their stems 4 at the end or terminal portion of a tree branch 1B1, 1B2 on a fruit tree. In this arrangement, the light protection case 5 provides protection to the cluster of fruit at the end of the tree branch, in accordance with the principles of the present invention.

FIG. 3 shows the light-transmissive fruit protection case 5 arranged in its closed configuration about a cluster of fruit pieces 3 hanging from their stems 4 along a portion of a tree branch on a fruit tree 1, providing protection to the cluster of fruit along the tree branch, in accordance with the principles of the present invention.

As shown in these figures, sunlight is permitted to transmit through each light-transmissive fruit protection case 5 towards the leaves and fruit protected within the enclosing protection case 5. Also, rainwater and atmospheric gases (e.g. air) are allowed enter and exit unfettered through a system of vents 5D allowing the exchange of atmospheric gases required for photosynthesis to naturally occur within the leaves and fruit protected within from birds, squirrels and other small creatures. These strategically placed apertures 5D are formed in the walls of the case so as to provide vents that allow air to pass freely to the interior of the case, and water and condensation to flow and drain freely, to prevent accumulation of water or the formation of fungus and mold inside the protection case.

### Specification Light-Transmissive Fruit Protection Case of the Illustrative Embodiment of the Present Invention

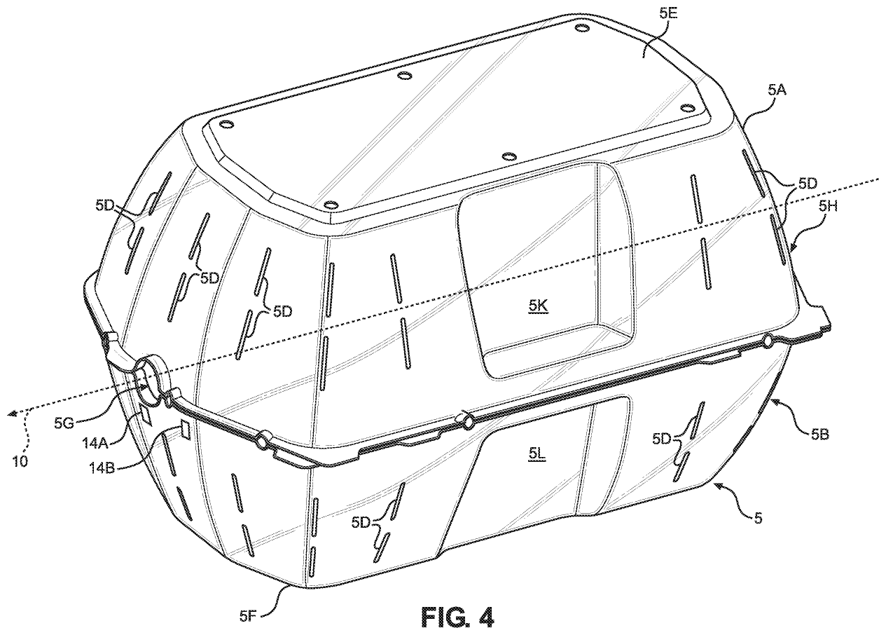

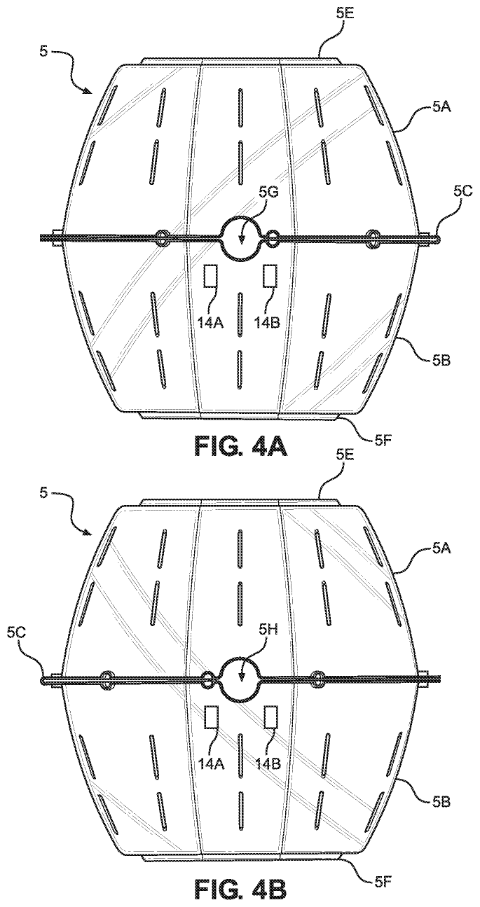

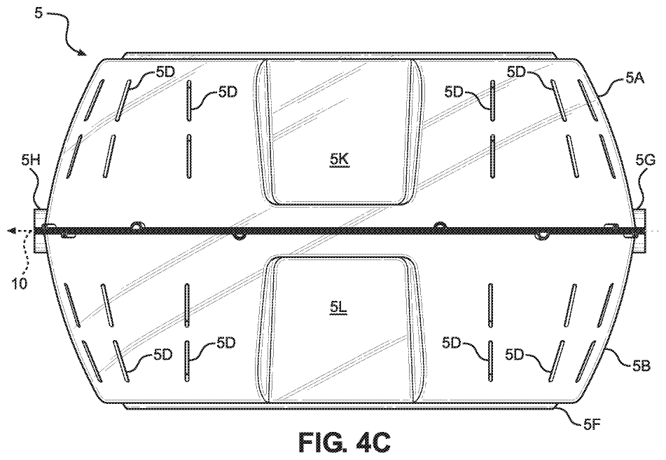

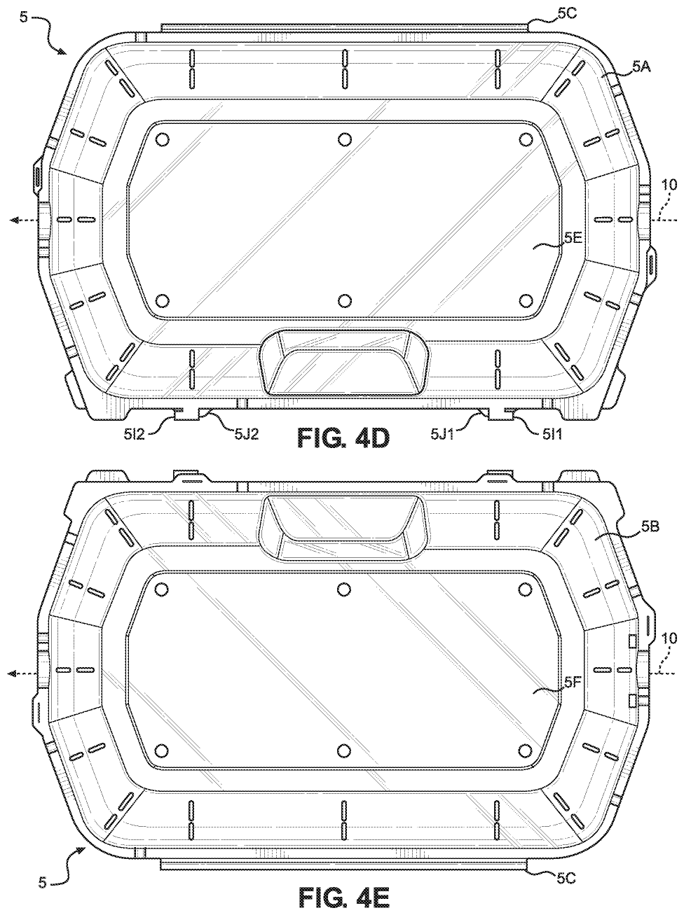

FIG. 4 shows the light-transmissive fruit protection case 5 of the illustrative embodiment arranged in its closed configuration while not installed about a cluster of fruit pieces hanging from their stems along or at the end portion of a tree branch.

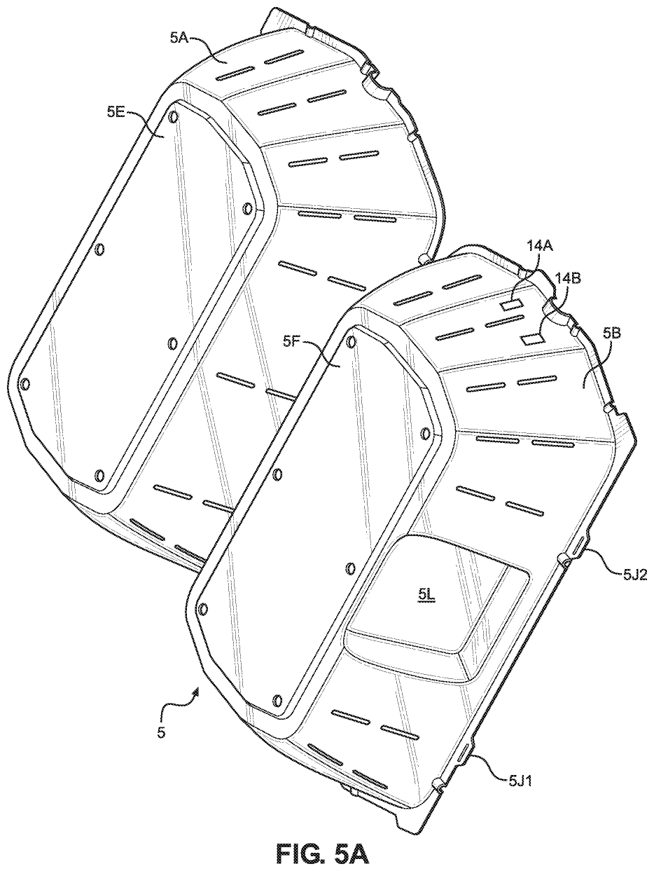

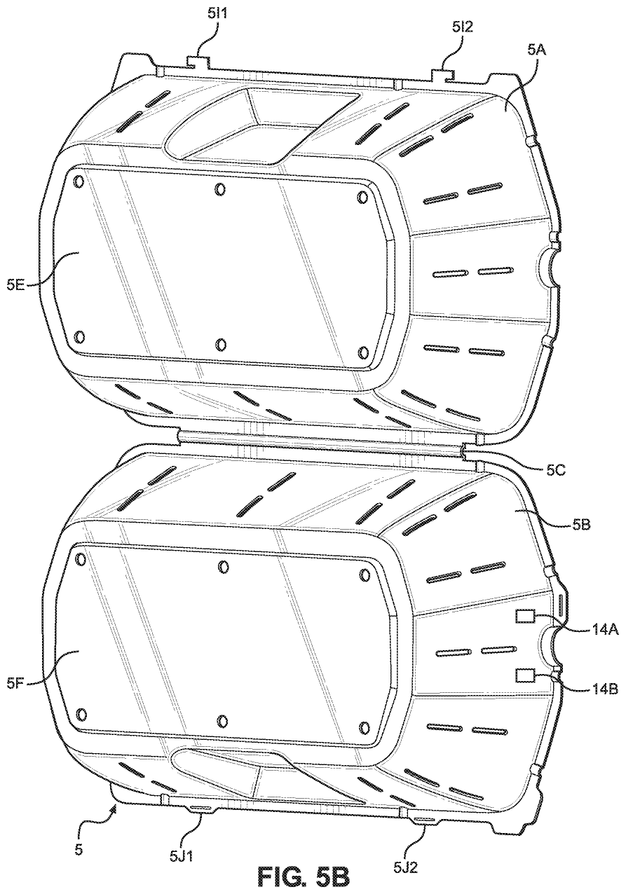

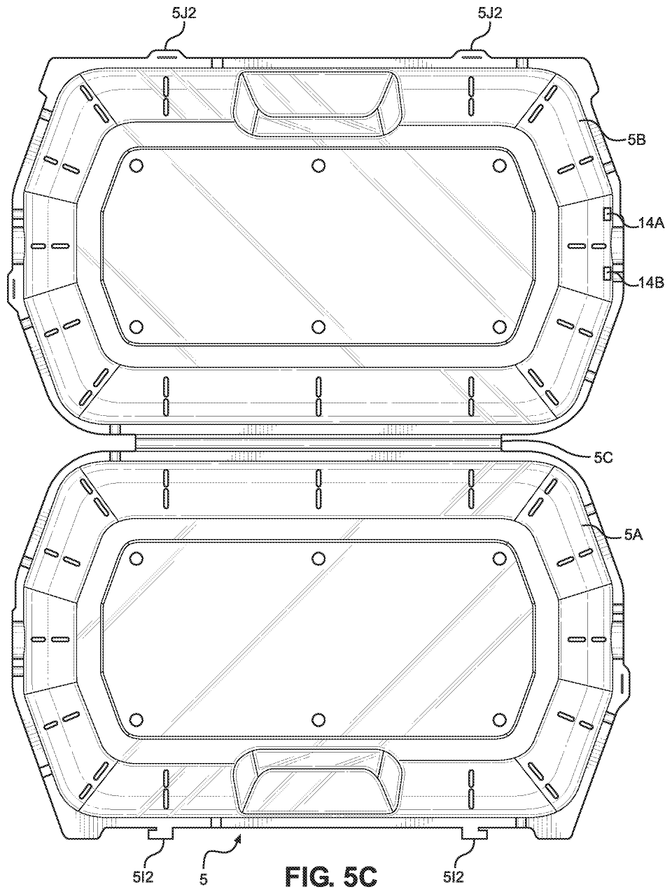

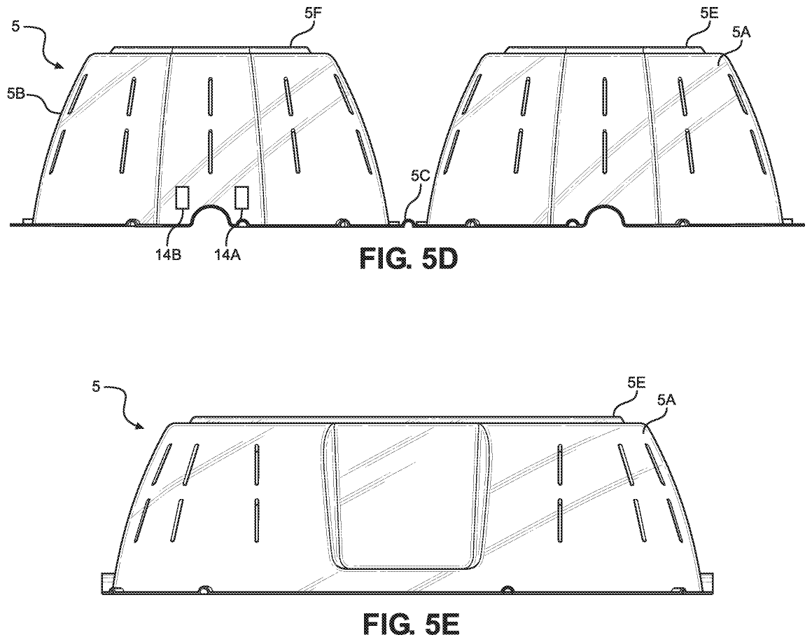

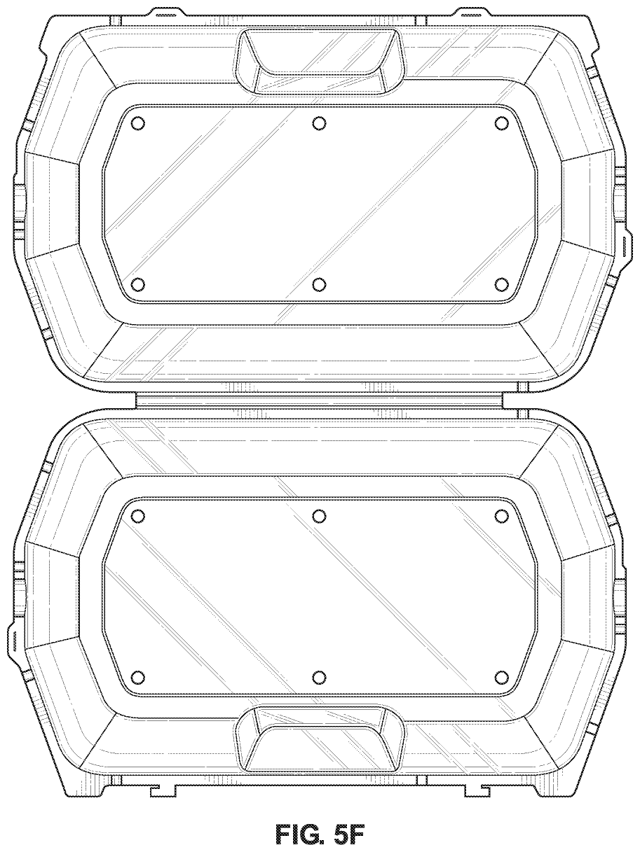

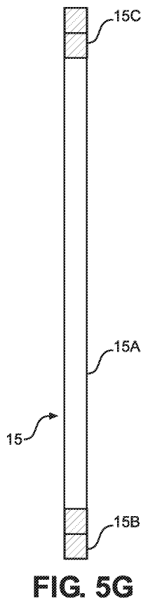

FIGS. 4A, 4B, 4C, 4D and 4E show the light-transmissive fruit protection case 5 arranged in its closed configuration while not installed about a cluster of fruit pieces hanging from their stems along or at the end portion of a tree branch. As shown, the light-transmissive fruit protection case 5 comprises: comprising: (i) the first and second case housing portions 5A and 5B connected about the common flexible hinge structure 5C; (ii) a plurality of air and water openings 5D formed about the side and top and bottom surfaces 5E and 5F of the first and second case housing portions 5A and 5B, respectively; (iii) the first and second branch access ports 5G and 5H formed on opposing ends of the case 5, along the longitudinal axis 10 of the case as shown, so as to allow the entry and passage of a fruit tree branch 1B1, 1B2 as required; (v) a pair of rectangular slots 14A and 14B formed in either the second case housing portion 5B, below each branch access port 5G and 5H, for passage of thin elongated rectangular plastic or fabric straps 15, provided with Velcro® releasable fasteners 15A, 15B and adapted for wrapping around the tree branch passing through the fruit protection case 5; and (iv) a set of reclosable fasteners 5I1 and 5J formed on the side end portions of the first and second case housing portions 5A and 5B, so as to releasably lock the protection case 5 in its closed protection configuration as shown in FIGS. 1, 2, 3, 4, 4A-4E, 7 and 8, and with ease, releasably unlock the protection case into its unblocked open configuration as shown in FIGS. 5A through 5F. For purposes of illustration, the second case housing portion 5B is considered the case housing portion that is stationarily mounted to the tree branch 1B1, 1B2 using the straps 15, while the first case housing portion 5A is considered the one free to rotate about its hinge structure 5C while installed about a tree branch.

As shown in FIGS. 2, 3, 7 and 8 the pair of rectangular slots 14A and 14B are preferably formed in the second case housing portion 5B, below each branch access port 5G and 5H, although slots 14A and 14B may be formed in the first case housing portion 5A, adjacent the branch access ports 5G and 5H. This arrangement of slots 14A and 14B allows each thin elongated rectangular strap 15 to pass through a rectangular slots 14A be wrapped about the tree branch 1B1, 1B2 on the interior side of the tree branch 1B1, 1B2, in a criss-cross fashion, and then be routed through the other rectangular slot 14B and then the two free ends of strap material 15A to be criss-cross wrapped about the tree branch outside the case, and then releasably fastened to each other using the Velcro® releasable fastening elements 15B, 15C to secure the wrapped strap in place as shown in FIG. 1. When the strap is installed though the rectangular slots 14A and 14B, and wrapped about the tree branch 1B1, 1B2, and fastened together with Velcro® fastening elements 15B, 15C, then the second or bottom case housing portion 5B will be securely mounted to the tree branch in its particular installation configuration, and the first or top case housing portion 5A will easily open about its hinged structure 5C, while the second or bottom case housing portion 5B is maintained relatively stationary, with respect to the fruit tree.

When the light-transmissive (optically clear) fruit case 5 of the present invention is used to protect a cluster of fruit handing from their stems on the terminal portion of a tree branch, as shown in FIGS. 1 and 2, only one Velcro® fastening type flexible strap 15 can be used and needed to secure the second case housing portion 5B of the fruit case 5 to the tree branch 1B2, as shown, using the cross-cross wrapping method described above.

When the light-transmissive (optically clear) fruit case 5 of the present invention is used to protect a cluster of fruit handing from their stems along a tree branch, as shown in FIGS. 1, 3, 7 and 8, one or two Velcro® fastening type flexible straps 15 can be used to secure the second case housing portion 5B of the fruit case 5 to the tree branch 1B1, as shown, using the cross-cross wrapping method described above.

At any time during the growing season, the flexible strap 15 can be removed, adjusted and reattached as required to accommodate the growth of the cluster of fruit pieces being protected within the fruit case 5.

FIGS. 55A, 5B, 5C, 5D, 5E and 5F shows the light-transmissive fruit protection case 5 arranged in its open configuration while not installed about a cluster of fruit pieces hanging from their stems along or at the end portion of a tree branch. As shown, the light-transmissive fruit protection case comprises: (i) the top and bottom panels 5E and 5F of the first and second case housing portions 5A and 5B connected about the common flexible hinge structure 5C; (ii) a plurality of air and water openings 5D formed about the side and top and bottom surfaces 5E and 5F of the first and second case housing portions 5A and 5B, respectively; (iii) the first and second branch access ports 5G and 5H formed on opposing ends of the case, along the longitudinal axis 10 of the case as shown in FIGS. 1-3, 4 through 4E and 7 and 8, so as to allow the entry and passage of a fruit tree branch 1B1; and (iv) a set of reclosable fasteners 511, 512 and 5J1, 5J2 formed on the side end portions of the first and second case housing portions 5A and 5B.

As shown in FIGS. 4A, 4B, 4C, 4D and 4E, when the first and second case housing portions 5A and 5B are folded about the common flexible hinge structure 5C and the protection case is arranged in its closed configuration as shown in FIGS. 1, 2, 3, 4, 4A-4E, 7, and 8, then an interior 3D volumetric space portion 9 is defined between the top and bottom surfaces 5E and 5F of the first and second case housing portions 5A and 5B, respectively, for enclosing and protecting the cluster of fruit 3 hanging from their stems 4 connected to the branches 1B1, 1B2. In the preferred illustrative embodiment, the interior 3D volumetric space 9 will be sufficient to allow a cluster of fruit pieces (e.g. 3-5 to grow freely) under the protection of the light and air transmissive fruit protection case 5 of the present invention, with integrated rain drain ports 5D that operated to minimize moisture building up within the case.

### Specification of a Method of Installing Light-Transmissive Fruit Protection Cases of the Present Invention About Clusters of Fruit Hanging From Stems Off of Branches on an Apple Tree

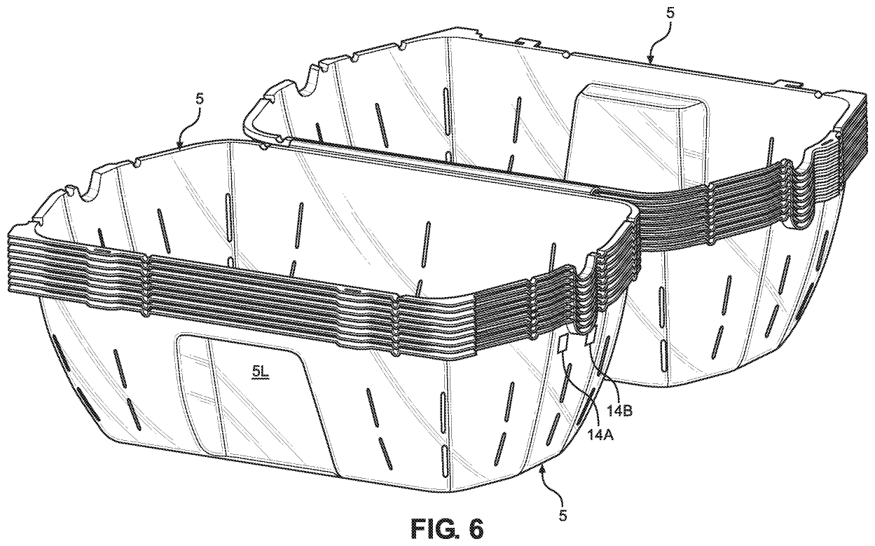

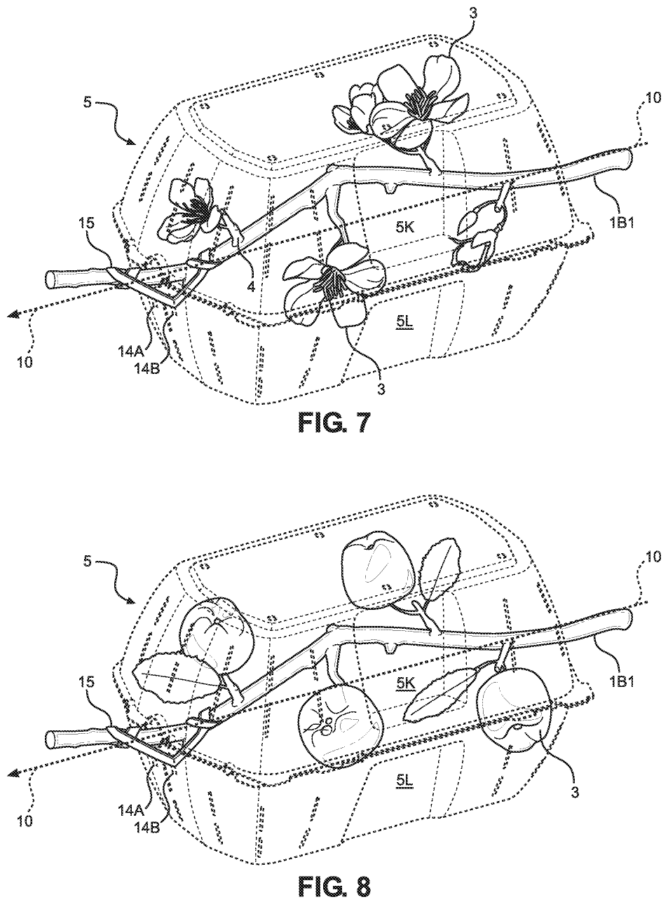

As described above, the light-transmissive fruit protection cases 5 of the present invention can be simply installed either at the terminal portion of or along a fruit tree branch where a cluster of fruit are hanging from their stems, as shown in FIGS. 2 and 3 respectively. Typically, the protection cases will be installed along fruit tree branches as illustrated in FIGS. 1, 2 and 3, after the fruit blossoms (e.g. apple blossoms) are fertilized by the process of pollination performed typically by bees, as discussed hereinabove. Once the apple blossoms have been fertilized and clusters of fruit 3 begin to grow along the branches of the fruit tree, protecting the fruit from birds, squirrels and other creatures will be essential to protect the produce for harvest time. The fruit clusters 3 can be protected from the birds, squirrels and other creative by installing a light-transmissive fruit protection case 5 about the pollinated apple blossoms 4 growing on a fruit tree branch as shown in FIG. 7, or about a cluster of small fruit 3 growing on a fruit tree branch as shown in FIG. 8. Typically, a plurality of light-transmissive protection cases 5 will be stacked up as shown in FIG. 6, for storage and shipping the package of cases to their destinations of use (e.g. home orchards). Once removed from the stack, the protection case 5 is arranged in its open configuration and then wrapped around the targeted cluster of fruit or fertilized fruit blossoms 3, and then rearranged in its closed configuration and locked as shown in FIGS. 1, 2 and 3.

When it rains, the raindrops can pass through the slotted vents 5D formed in the surfaces of the case housing portions 5A and 5B and properly drain to prevent moisture buildup, condensation and fungus.

When spraying apples, pears, peaches and other fruit on ornamental trees for fungus, mold and insects such as mites, etc., the light-transmissive fruit protection cases 5 can be easily opened (i.e. arranged in their open configuration), the foliage and fruit sprayed, and after drying, the cases can be reclosed (i.e. arranged into the closed configuration) to protect the clusters of fruit inside.

If desired, the fruit grower can use a Sharpie® pen to make marks on the outside of the light-transmissive fruit protection case 5, particularly in the indented rectangular sections 5K and 5L on side wall portions 5A and 5B respectively shown in FIGS. 2, 3, 4, 4C, 6, 7, and 8, to provide each case with a unique identifier, and to indicate the date on which the fruit blossom was encased, and the date which it was sprayed, and the date when it was picked from the tree.

Other helpful notations may be made on the protection case at indented sections 5K and 5L by the grower, for collection at the end of the season. For example, the protection cases 5 of the present invention can be barcoded to identify the certain clusters or pieces of fruit growing on the tree branches and protected by a specific fruit protection case.

Alternatively, the indented sections 5K and 5L provide a clear view into the interior of the fruit protection case, through which digital photos can be captured and stored for various purposes. Also, a mobile app can be developed and installed on a mobile phone to periodically record the barcode identifier on the fruit protection case 5 and then link some captured photographs of the fruit and store these photos under barcode identifier during the life cycle of the fruit. This might help to organize an interesting collection of photos of selected pieces of fruit during their lifecycle, from fruit blossom to mature pieces of fruit.

### Modifications to the Present Invention Which Readily Come to Mind

While the light-transmissive fruit protection case 5 has been shown to protect a cluster of fruit pieces in each case structure 5, as will typically be the practice, it is understood that in many instances only one piece of fruit, or perhaps two pieces of fruit, will be encased and allowed to grow within the protection of the fruit protection case 5 in accordance with the principles of the present invention. However, in many instances, two or more fruit blossoms w be pollinated and produce clusters of fruit while hanging in close proximity to each other from a common tree branch. The light-transmissive fruit protection case 5 of the present invention is particularly well adapted to serve and protect such clusters of fruit in many diverse growing environments, occupied by birds, squirrels, deer and other small creatures.

While the preferred embodiment of the present invention will typically employ one or more Velcro® fastening type straps 15 to help secure the bottom case housing portion 5B to a tree branch, it is understood that in some applications, fastening straps 15 may not be used while the light-transmissive fruit protection case 5 is arranged and configured around a cluster of fruit pieces under protection.

Also, while the fastener straps 15 of the illustrative embodiment have been shown to be flat and rectangular in shape, as shown in FIG. 5G, and capable of being dissattached and reattached to the tree branch by a wrapping operation, it is understood that the flexible refastenable straps 15 can be realized in other form factors, such as, a piece of string or a piece of chord, provided with Velcro® fastening type elements at the end portions of the string piece or chord piece, or simply tied together with a knot arrangement, well known in the art. Such kinds of elongated fastener are a releasable fastener that can be dissattached and reattached. Alternatively, nylon cable zip ties or tag fasteners can be used to fasten the fruit protection case 5 to a tree branch, in lieu of Velcro® fastening type straps 15, shown in FIG. 5G.

While several modifications to the illustrative embodiments have been described above, it is understood that various other modifications to the illustrative embodiment of the present invention will readily occur to persons with ordinary skill in the art. All such modifications and variations are deemed to be within the scope and spirit of the present invention as defined by the accompanying Claims to Invention.

What is claimed is:

1. A light-transmissive fruit protection case for installation about a cluster of fruit pieces hanging from stems along or at an end portion of a tree branch, so as to protect said cluster of fruit pieces from birds, squirrels, deer and other creatures while growing on said tree branch, said light-transmissive fruit protection case comprising:
first and second case housing portions connected about a common flexible hinge structure,
wherein said first and second case housing portions each have side, top and bottom surfaces;
a plurality of air and water openings formed about said side, top and bottom surfaces of said first and second case housing portions;
first and second branch access ports formed on opposing ends of said first and second case housing portions to allow the entry and passage of a fruit tree branch; and
a set of reclosable fasteners formed on said side end portions of said first and second case housing portions.

2. The light-transmissive fruit protection case of claim 1, wherein when said first and second case housing portions are folded about said common flexible hinge structure in said closed configuration, an interior 3D space portions is defined between the side and top and bottom surfaces of said first and second case housing portions for enclosing said cluster of fruit.

3. The light-transmissive fruit protection case of claim 1, which further comprises a pair of slots and formed in said second case housing portion, adjacent each branch access port, for passage of an elongated fastener adapted for wrapping around the tree branch passing through said light-transmissive fruit protection case, and securing the light-transmissive fruit protection case to said tree branch.

4. The light-transmissive fruit protection case of claim 3, wherein said elongated fastener is a releasable fastener that can be dissattached and reattached.

5. A plurality of light-transmissive fruit protection cases as recited in claim 1, arranged in a stacked-up open configuration for storage and shipping to destinations of use.

6. A light-transmissive fruit protection case for installation about a cluster of fruit pieces hanging from stems along or at an end portion of a tree branch, so as to protect said cluster of fruit pieces from birds, squirrels, deer and other creatures while growing on said tree branch, said light-transmissive fruit protection case comprising:
first and second case housing portions connected about a common flexible hinge structure;
wherein said first and second case housing portions each having side, top and bottom surfaces;
a plurality of air and water openings formed about the side, top and bottom surfaces of the first and second case housing portions;
first and second branch access ports are formed on opposing ends of the first and second case housing portions, along its longitudinal axis, so as to allow the entry and passage of a fruit tree branch; and
a set of reclosable fasteners are formed on the side end portions of the first and second case housing portions to releasably lock the case in a closed configuration once arranged about said cluster of fruit hanging from said tree branch.

7. The light-transmissive fruit protection case of claim 5, which further comprises a pair of slots and formed in said second case housing portion, below each branch access port, for passage of an elongated fastener adapted for wrapping around the tree branch passing through said light-transmissive fruit protection case, and securing the light-transmissive fruit protection case to said tree branch.

8. The light-transmissive fruit protection case of claim 7, wherein said elongated fasteners is a releasable that can be dissattached and reattached.
